(19) United States
(12) Patent Application Publication
(10) Pub. No.: US 2011/0112973 A1
(43) Pub. Date: May 12, 2011

(54) Automation for Governance, Risk, and Compliance Management

(75) Inventor: Ashvinkumar J. Sanghvi, Sammamish, WA (US)

(73) Assignee: MICROSOFT CORPORATION, Redmond, WA (US)

(21) Appl. No.: 12/615,034

(22) Filed: Nov. 9, 2009

(51) Int. Cl. G06Q 99/00

(52) U.S. Cl. 705/317

(57) ABSTRACT

Technologies are described herein for automating governance, risk, and compliance management (GRC). Through the utilization of the technologies and concepts presented herein, GRC management may be automated to thereby provide significant reduction in customization per installation or customer. Compliance management of regulations for managed entities may entail receiving a set of control objectives mapped to the regulations. A set of scopes mapped to the managed entities may be received. Harmonized test results for the control objectives may be generated. Harmonized test results may be identified for a subset of the control objectives mapped to one or more specified regulations for the managed entities within a specified one of the set of scopes. Also, a compliance report may be generated based upon the identified harmonized test results.

### BACKGROUND

Governance, risk and compliance management (GRC) has become an important consideration for many organizations. Governance is the process of choosing actions based on the risk and being accountable for the choices made. Risk provides the context by which a possible exposure and cost of remedy may be evaluated. Compliance management is the discipline of interpreting high level policies, translating them into objectives, and tracking their adherence.

Without GRC, an organization may be precluded from operating in a certain jurisdiction, selling to specific customers, or participating in a specific associated community. GRC can become a specifically unique problem for each organization or each audit type because of changing regulations, technologies, and enterprise environments. Thus GRC management can become very expensive, labor intensive, and error prone work. Furthermore information technology (IT) departments may repeatedly incur these expenses. GRC management can account for up to 15 percent, or more, of all IT spending.

The manual process of translating policies and aggregating reports across many layers of IT operations and among heterogeneous components within a layer is problematic. The labor intensive, error prone, scatter-shot approach often utilized by organizations requires cobbling together products and hand collecting bits of information from disparate systems in hopes of verifying compliance. As such, GRC management is generally addressed by vendors with offerings for services and not automated systems.

It is with respect to these and other considerations that the disclosure made herein is presented.

### SUMMARY

Technologies are described herein for automating governance, risk, and compliance management (GRC). Through the utilization of the technologies and concepts presented herein, GRC management may be automated to thereby provide significant reduction in customization per installation or customer. Compliance management of regulations for managed entities may entail receiving a set of control objectives mapped to the regulations. A set of scopes mapped to the managed entities may be received. Harmonized test results for the control objectives may be generated. Harmonized test results may be identified for a subset of the control objectives mapped to one or more specified regulations for the managed entities within a specified one of the set of scopes. Also, a compliance report may be generated based upon the identified harmonized test results.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating an enterprise governance, risk, and compliance management (GRC) hierarchy according to one or more embodiments presented herein;

FIG. 2 is a block diagram illustrating an enterprise GRC hierarchy according to one or more embodiments presented herein;

FIG. 3 is a block diagram illustrating a GRC platform according to one or more embodiments presented herein;

FIG. 4 is a block diagram illustrating abstraction layers for automated governance, risk, and compliance management according to one or more embodiments presented herein;

FIG. 5 is a flow diagram showing an illustrative process for automating governance, risk, and compliance management according to one or more embodiments presented herein; and

FIG. 6 is a computer architecture diagram showing an illustrative computer hardware architecture for a computing system capable of implementing embodiments presented herein.

### DETAILED DESCRIPTION

The following detailed description is directed to technologies for automating governance, risk, and compliance management (GRC). Through the utilization of the technologies and concepts presented herein, GRC management may be automated to thereby provide significant reduction in customization per installation or customer. GRC management can be critical for a corporation for various reasons. For example, compliance with the Sarbanes-Oxley Act (SOX) may be required of an American public company. Similarly, certain jurisdictions may require other compliance, such as J-SOX in Japan. Other regulatory compliance, such as the Health Insurance Portability and Accountability Act (HIPAA) or business community compliance such as ISO 27001 may be managed using the GRC management technology disclosed herein.

Three categories of factors relevant to GRC may be addressed as regulations, enterprise configuration, and technology. Abstraction knowledge may be applied to map complex, real world factors onto three abstraction layers. The three abstraction layers may be specified as control objectives, scopes of managed entities, and control objective test results. Specifying these abstraction layers can support automated GRC management even in light of diverse and changing regulations, enterprise configurations, or technologies. Such automation can replace costly GRC management services with management technology that can be developed once and sold, purchased, and deployed repeatedly in any combination.

A compliance master framework can contain one or more frameworks. The frameworks can harmonize, de-duplicate, and organize control objectives in a regulation and technology independent manner. A control objective can be specified as a layer of abstraction between business policies or compliance policies and technical implementations and automation. A simple hierarchy of English statements may be mapped to authority documents outlining regulations or policies at one end and technical verification at the other end. The framework can be plugged into a larger IT management system to relate scopes of managed entities and technologies in support of GRC automation.

A library of abstraction knowledge can bring in the relevant data from the appropriate management frameworks and map the data to a technology independent layer of control objective test results. A configuration management database (CMDB) can map compliance programs to scopes that contain managed entities over multiple containment relationships. The resultant GRC automation can support the automatic generation of GRC compliance reports without manual intervention.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, concepts and technologies for automating governance, risk, and compliance management will be described.

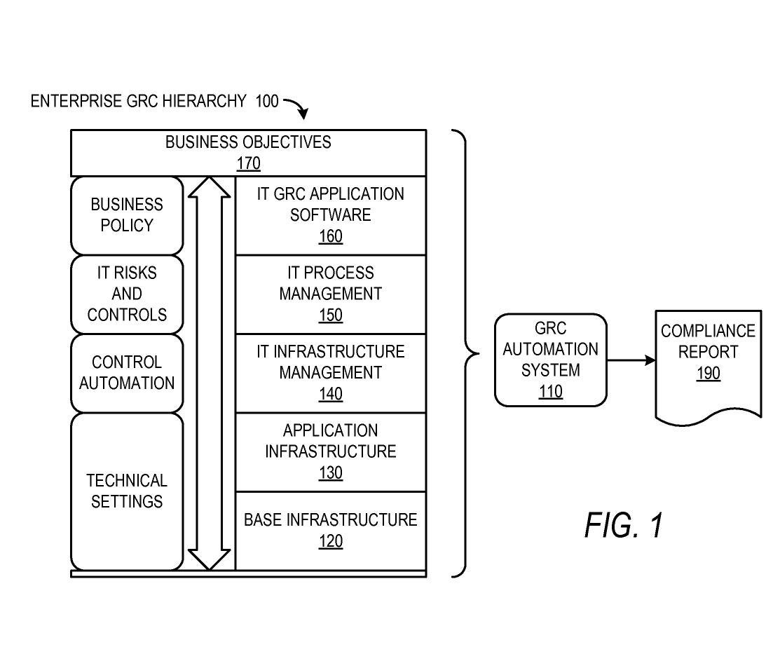

Turning now to FIG. 1, a block diagram illustrates an enterprise GRC hierarchy 100 according to one or more embodiments presented herein. GRC in an IT context can reach through all layers of IT operations to support compliance management. As such, a GRC automation system 110 may call upon resources and information distributed throughout various IT systems to test compliance. Generally, compliance management may result in, at least, the generation of a compliance report 190. The compliance report 190 may be used in internal monitoring and improvement activities as well as in support of, or defense of, an external compliance audit.

Layers within the enterprise GRC hierarchy 100 may be represented from the bottom up starting with hardware and applications up through a set of business objectives 170. Base infrastructure 120 may include hardware, operating systems, and infrastructure services. Application infrastructure 130 may include application middleware and applications. Together, base infrastructure 120 and application infrastructure 130 may manifest within GRC as various technical capabilities. Such technical capabilities can be configured via technical settings. The behavior of the technical capabilities may be observed by audit events. IT infrastructure management 140 may manifest within GRC as control automation. IT process management 150 may manifest within GRC as IT risks and controls. Finally, IT GRC application software 160 can test and report against business policy such as the business objectives 170.

GRC automation 110 may include the GRC application software 160. However, the complete GRC solution may operate at all layers of IT operation. As such, attributes or features of products operating within the layers of base infrastructure 120, application infrastructure 130, IT infrastructure management 140, and IT process management 150 may interface to and support the GRC application software 160 to realize a complete GRC automation system 110.

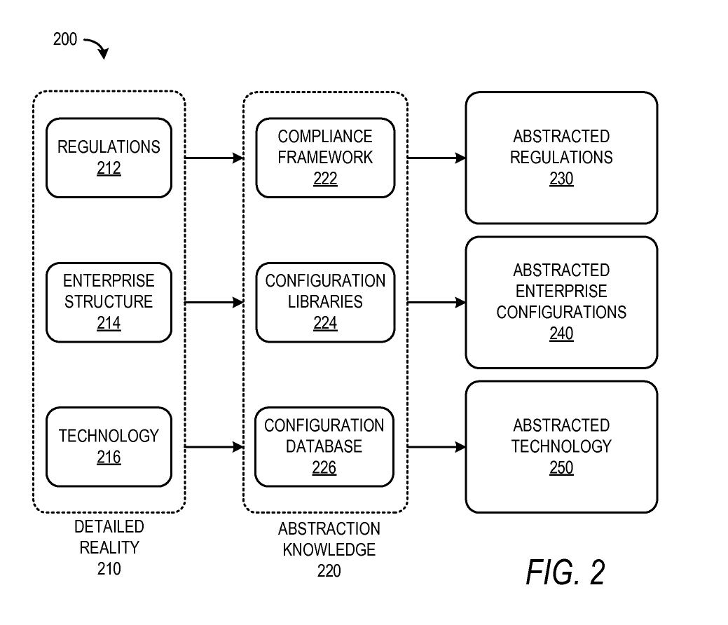

Referring now to FIG. 2, a block diagram illustrates an abstraction model 200 used for the GRC automation system 110 according to one or more embodiments presented herein. Technologies associated with the GRC automation system 110 can mitigate the challenge of nearly constant change in the three realms of regulation, enterprise configuration, and technology through the effective us of abstraction. The detailed reality information 210 of the real world can include a wide array of rapidly changing and ill defined elements such as regulations 212, enterprise structure 214, technology 216, or others. The regulations 212 may be English language regulations or policy statements. The enterprise structure 214 may contain information about IT system configurations. While the technology 216 may contain real world information about the operation of technology within the IT systems. The open ended fashion in which reality information 210 may be provided can defy automated analysis.

Abstraction knowledge 220 may support mapping the detailed reality 210 of the real world into abstraction layers. The abstraction knowledge 220 may be supplied as rules, expressions, or other information configured to aid in transforming real world information such as the detailed reality information 210 into abstract representations. The GRC automation 110 disclosed herein can support the abstraction of a complex detailed reality 210 which may include policies and/or regulations stated in human language. These abstractions can support the automatic production of compliance reports 190 and track compliance management against the policies or regulations. Abstraction knowledge 220 can include a compliance framework 222, configuration libraries 224, a configuration database 226, or an other mechanism for providing information useful to abstract detailed reality 210.

A compliance framework 222 may be applied to extract abstracted regulations 230 from a complex array of regulations 212, possibly including policies, as found in the detailed reality 210 of the real world. Tens of thousands of regulations may be enacted in any country in a given year. In the United States examples may include SOX, HIPAA, ISO, and so forth. These regulations may change frequently. Also the regulations may be expressed as authority documents written in complex legal language and subject to multiple interpretations. Abstraction knowledge 220 may be leveraged to represent these regulations and various other policies as abstracted regulations 230.

Configuration libraries 224 may be applied to extract abstracted enterprise configurations 240 from a complex array of enterprise structure 214 found in the detailed reality 210 of the real world. The complexity may be exacerbated by current trends towards virtualization, outsourcing, cloud computing, and service-oriented architectures (SOA). These trends pose added challenges for compliance. As resources are moved around in a data center to optimize costs, availability, and performance, the problem of tracking compliance may increase. Similarly, improvements in rapid application development and SOA style services pose increased challenges due to of rapid change introduction. Furthermore, users empowered by choice of location, devices, and mobility can further complicate compliance tracking. The GRC automation system 110 can mitigate these challenges.

A configuration database 226, such as a configuration management data base (CMDB), may be applied to extract abstracted technology 250 information from a complex array of information related to technology 216 and related infrastructure found in the detailed reality 210 of the real world. Organizations are dealing with a vast portfolio of technology that is versioned and retired regularly. Compliance features associated with the technology also change and instrumentation morphs and is often undocumented or documented in technical jargon. Thus, each organization may be quite different and every audit may be different as well. The GRC automation system 110 can mitigate these challenges.

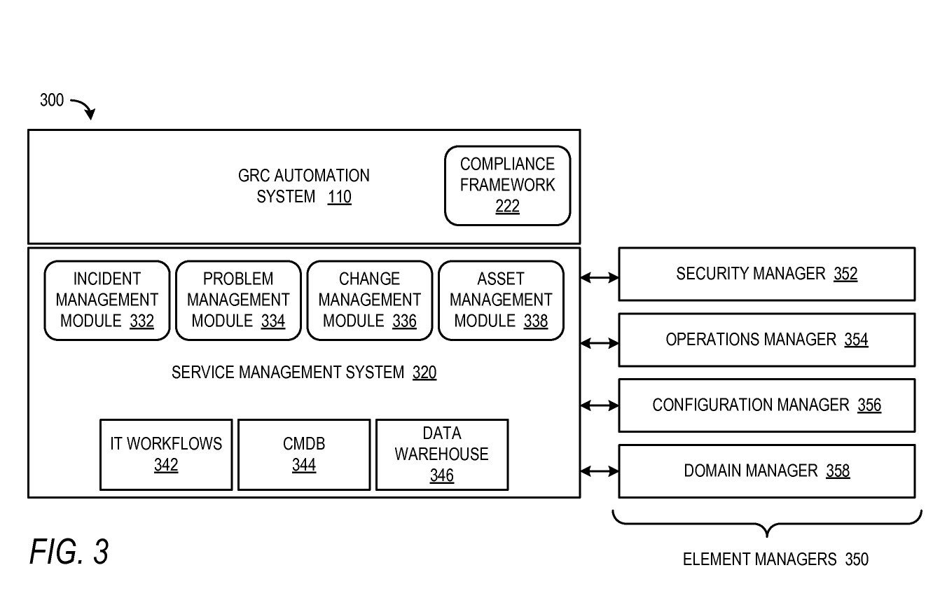

Referring now to FIG. 3, a block diagram illustrates a GRC platform 300 according to one or more embodiments presented herein. The GRC automation system 110 may operated in association with a service management system 320. One example of a service management system 320 is SYSTEM CENTER SERVICE MANAGER from MICROSOFT CORPORATION.

The service management system 320 can generally support IT workflows 342 for IT processes. The service management system 320 can support the GRC automation system 110, in part, by leveraging its access to IT workflows 342. The service management system 320 may also have visibility into other IT process modules such as an incident management module 332, a problem management module 334, a change management module 336, and an asset management module 338. These and various other modules such as a release management module and a user management module may be leveraged by the service management system 320 for use with the GRC automation system 110.

The service management system 320 can also leverage visibility into various element managers 350 for use in GRC automation 110. The service management system 320 may interface with element managers 350 such as a security manager 352, an operations manager 354, a configuration manager 356, and a domain manager 358. FORE FRONT from MICROSOFT CORPORATION is one example of a security manager 352. SYSTEM CENTER OPERATIONS MANAGER or OPERATIONS MANAGER 2007 SERVER from MICROSOFT CORPORATION are examples of operations managers 354. CONFIGURATION MANAGER or CONFIGURATION MANAGER 2007 SERVER from MICROSOFT CORPORATION are examples of configuration managers 356. ACTIVE DIRECTORY from MICROSOFT CORPORATION is one example of a domain manager 358. One implementation strategy of the GRC automation system 110 discussed herein may be to include the necessary layers of abstraction, alignment, knowledge and automation into multiple areas of IT operations to support the GRC automation system 110.

The service management system 320 can support a configuration management data base (CMDB) 344 and an associated data warehouse 346 to automatically maintain an inventory of managed entities, work tasks, and various associated attributes and relationships. The CMDB can map compliance programs to scopes containing managed entities with one or more containment relationships. When enterprise configuration changes occur, the appropriate and accurate reports can be automatically created or updated without manual intervention. An example of such an enterprise configuration change may include changes to elements of a service related to a business process. Additional examples may include changes to devices or changes to access methods of a user.

The GRC automation system 110 can operate a compliance framework 222 to provide managers, corporate officers, and auditors with flexible tools for performing compliance management functions. The compliance framework 222 can support automatic translation of regulations and standards from various countries into harmonized control objectives 410. These functions may include the ability to define policies, track risks, monitor compliance activities, monitor progress, generate reports, and to create and run compliance programs. As a form of extensible abstraction knowledge 220, these regulations and standards may be updated repeatedly in the futures as needed.

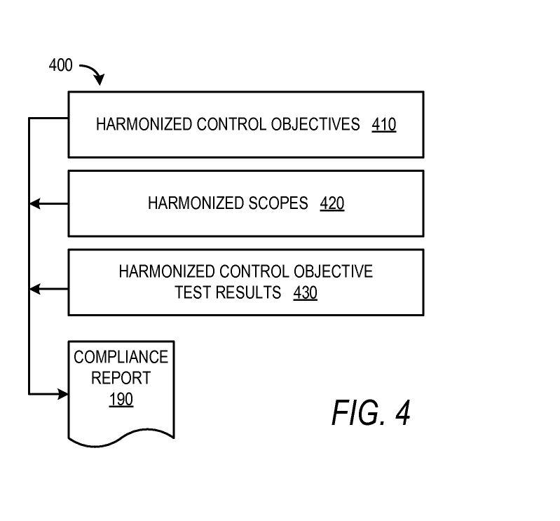

Referring now to FIG. 4, a block diagram illustrates abstraction layers 400 for automating governance, risk, and compliance management according to one or more embodiments presented herein. The GRC automation system 110 disclosed herein can leverage three layers of abstraction. A first abstraction layer can involve harmonized control objectives 410. The harmonized control objectives 410 may be regulation agnostic goal statements designed to reduce or eliminate risk or to meet one or more requirements. For example, a control object to synchronize system clocks may be implemented as one of the harmonized control objectives 410. Each harmonized control objective 410 can be shared across many regulations supporting a de-duplication of data collection and savings from consolidating compliance programs. Sharing of harmonized control objectives 410 can also reduce repeated interpretation of regulatory language.

A second abstraction layer can involve harmonized scopes 420. The harmonized scopes 420 may be viewed as abstract containers of managed entities and process artifacts that have to meet a set of policies. One example of an abstract container may be a set of retail services. Examples of managed entities may include computer systems, services, databases, clusters, services, or security mechanisms. Examples of process artifacts may include work items, change orders, incident records, or release orders. Examples of policies may include password length, file access parameters, or other rule that is being managed or other had behavior, configuration or status evaluated for compliance management or tracking. The contents of a container or a harmonized scope 420 can change dynamically over time. The CMDB 344 can contain service maps used to map harmonized scopes 420 to contained entities.

A third abstraction layer can involve harmonized control objective test results 430. These test results may be reported from many different modules on many different technologies for a particular objective.

In light of these abstraction layers, the problem of reporting a level of compliance to one or more regulations for a set of assets or processes that fall within a certain category and are implemented using various technologies may be recast. The problem may be translated into reporting a percentage outcome of harmonized control object test results 430 for a harmonized scope 420 according to harmonized control objectives 410 associated with one or more regulations. This problem may be approached by introducing automation to map regulations to harmonized control objectives 410, map harmonized scopes 420 to managed entities and work items, and produce the harmonized control objective test results 430 for a specified harmonized control objective 410 associated with a specified technology or process. Defining these three areas of automation may be said to take N, M, and O operations respectively. Thus, the total number of operations is N+M+O, instead of N*M*O operations to manually verify all compliance requirements. This combinatorial benefit may support automatic adjustment for any combination of changes in the system and without impacting the timely and automatic generation reports.

Compliance programs are generally targeted to a certain scope for a certain set of regulations. A compliance report 190 can be generated for any such program from a result matrix populated by automation provided for data collection and interpretation. GRC automation 110 can select a set of scopes and control objectives and evaluate the corresponding set of managed entity control results against a threshold for a point in time. For example, 95% of computers in a sales department should follow a password policy. The compliance report 190 can indicate which control objectives were not met and then drill down to indicate any control test activity failures. The failures may be specified with their associated managed entities and/or times.

A control test activity may be considered as an extensible set of control objective verification activities. Control test activities may be specific to technology (e.g. WINDOWS XP from MICROSOFT CORPORATION), management technology (e.g. SYSTEM CENTER CONFIGURATION MANAGER from MICROSOFT CORPORATION), or test approach. The control test activity results for managed entities may be populated by control test activities.

According to one or more embodiments, abstraction knowledge 220 can be monetized through knowledge updates or subscriptions to support changing regulations and technology. According to one or more other embodiments, third party frameworks and plug-ins may be supported. Such subscriptions or plug-ins may assist an organization in making sense of specialized regulations in different parts of the world or different industries. Similarly, the subscriptions or plug-ins may provide information for different technologies, such as BLACKBERRY mobile devices, or MySQL. A plug-in vendor may instantly benefit from the infrastructure in place and existing abstraction knowledge 220. An on-line content store model may be used to deploy knowledge plug-ins. Using the store, members of the user community can independently post their knowledge for specific regulations, standards, processes or technologies for customers to consume.

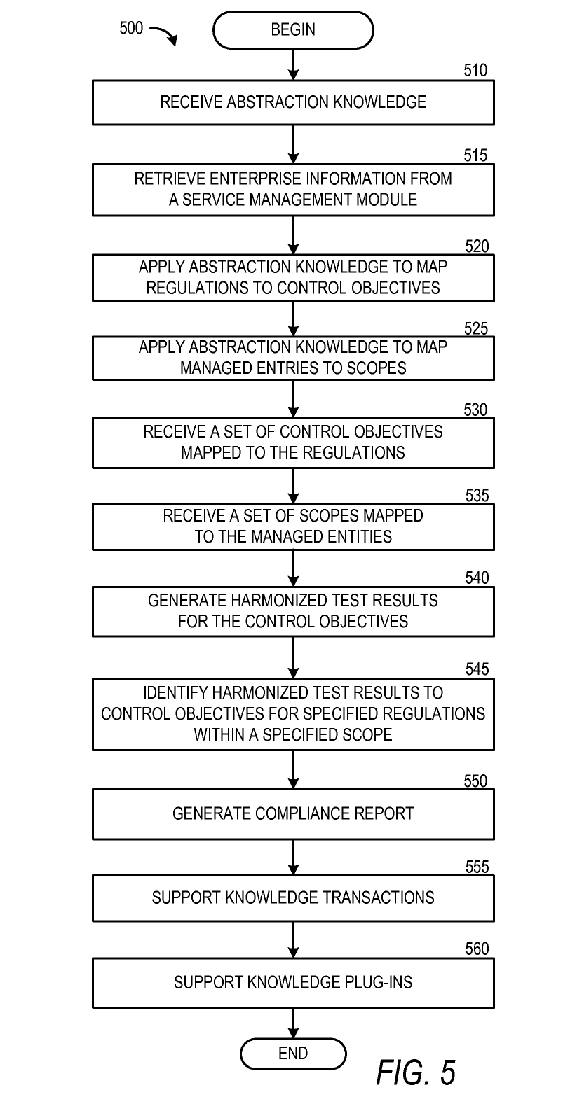

Referring now to FIG. 5, additional details will be provided regarding the embodiments presented herein for automating governance, risk, and compliance management. In particular, FIG. 5 is a flow diagram illustrating a method 500 for automating governance, risk, and compliance management according to embodiments presented herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may be performed sequentially, in parallel, or in a different order than as described herein.

The method 500 begins at operation 510 where the GRC automation system 110 can receive abstraction knowledge 220. The abstraction knowledge may be received as part of the GRC automation system 110, from a knowledge subscription, from a knowledge plug-in, or from an on-line content store.

At operation 515, the GRC automation system 110 can retrieve enterprise information from one or more modules associated with the service management system 320. Various details about the managed entities within the enterprise may be obtained from the workflows 342, the CMDB 344, the data warehouse 346, or any number of element managers 350.

At operation 520, the GRC automation system 110 may apply abstraction knowledge 220 to map regulations to control objectives 410. The control objectives 410 can be generated as abstractions of regulations and policies found within the detailed reality 210 of the real world.

At operation 525, the GRC automation system 110 may apply abstraction knowledge 220 to map managed entries to scopes 420. The scopes 420 can be generated as abstractions of groups of managed entities found within the detailed reality 210 of the real world.

At operation 530, the GRC automation system 110 may receive a set of control objectives 410 mapped to the regulations. The control objectives 410 may be received from operation 520 or from a separate source such as a knowledge subscription of knowledge plug-in.

At operation 535, the GRC automation system 110 may receive a set of scopes 420 mapped to the managed entities. The scopes 420 may be received from operation 525 or from a separate source such as a knowledge subscription of knowledge plug-in.

At operation 540, the GRC automation system 110 may generate harmonized test results for the control objectives. Applying control objectives 410 to managed entities can yield test results associated with the control objectives 410.

At operation 545, the GRC automation system 110 may identify harmonized test results 430 for a subset of the control objectives 410 mapped to specified regulations for managed entries within a specified scope 420. As such, a percentage outcome of harmonized control object test results 430 for a harmonized scope 420 according to harmonized control objectives 410 associated with one or more regulations may be determined.

At operation 550, the GRC automation system 110 may generate a compliance report 190. The compliance report 190 may be based upon the harmonized test results 430 from operation 545.

At operations 555, the GRC automation system 110 may support knowledge transactions to mobilize abstraction knowledge 220. The transactions may include knowledge subscriptions, sales, purchases, deployments, etc.

At operation 560, the GRC automation system 110 may support knowledge plug-ins to mobilize abstraction knowledge 220. This mobilization may occur between vendors and customers or from customer to customer through an on-line content store. The method 500 may terminate after operation 560 or the method 500 may be repeated continuously or periodically.

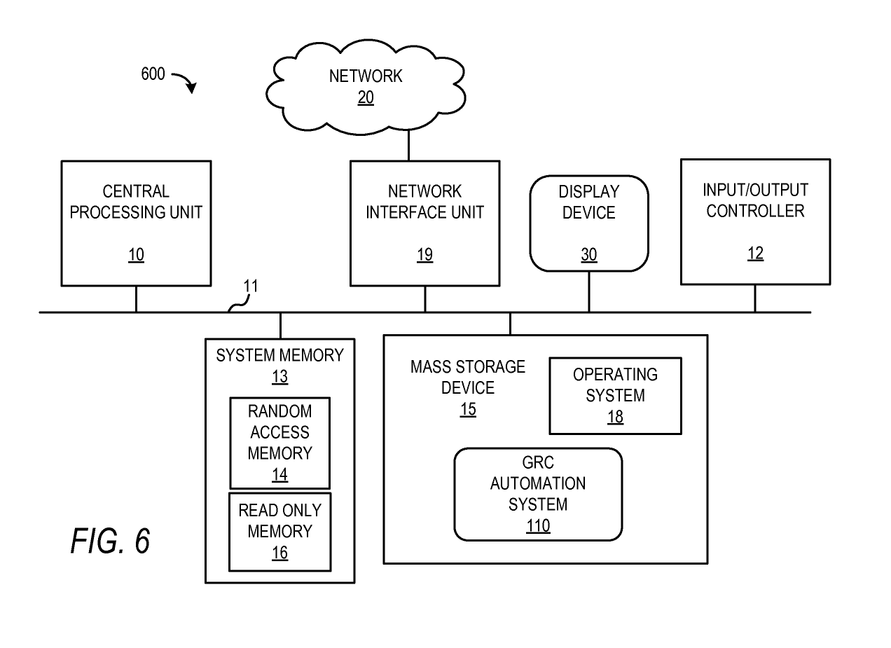

Turning now to FIG. 6, an illustrative computer architecture 600 can execute software components described herein for automating governance, risk, and compliance management. The computer architecture shown in FIG. 6 illustrates a conventional desktop, laptop, or server computer and may be utilized to execute any aspects of the software components presented herein. It should be appreciated however, that the described software components can also be executed on other example computing environments, such as mobile devices, television, set-top boxes, kiosks, vehicular information systems, mobile telephones, embedded systems, or otherwise. The computer architecture 600 may apply to the computer executing the program modules associated with the GRC automation system 110.

The computer architecture illustrated in FIG. 6 can include a central processing unit 10 (CPU), a system memory 13, including a random access memory 14 (RAM) and a read-only memory 16 (ROM), and a system bus 11 that can couple the system memory 13 to the CPU 10. The system memory 13 may provide memory 120 used for the GRC automation system 110. A basic input/output system containing the basic routines that help to transfer information between elements within the computer 400, such as during startup, can be stored in the ROM 16. The computer 400 may further include a mass storage device 15 for storing an operating system 18, software, data, and various program modules, such as those associated with the GRC automation system 110. The program modules can execute portions of software components, processes, and routines described herein.

The mass storage device 15 can be connected to the CPU 10 through a mass storage controller (not illustrated) connected to the bus 11. The mass storage device 15 and its associated computer-readable media can provide non-volatile storage for the computer 600. Although the description of computer-readable media contained herein refers to a mass storage device, such as a hard disk or CD-ROM drive, it should be appreciated by those skilled in the art that computer-readable media can be any available computer storage media that can be accessed by the computer 600.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 20. The computer 600 may connect to the network 20 through a network interface unit 19 connected to the bus 11. It should be appreciated that the network interface unit 19 may also be utilized to connect to other types of networks and remote computer systems. The computer 600 may also include an input/output controller 12 for receiving and processing input from a number of other devices, including a keyboard, mouse, or electronic stylus (not illustrated). Similarly, an input/output controller 12 may provide output to, a printer, or other type of output device (also not illustrated). A display device 30 may be used for providing output from the computer 600 in the form of text, graphics, video, graphical user interface, any other user interface elements, or any combination thereof.

As mentioned briefly above, a number of program modules and data files may be stored in the mass storage device 15 and RAM 14 of the computer 600, including an operating system 18 suitable for controlling the operation of a networked desktop, laptop, server computer, or other computing environment. The mass storage device 15, ROM 16, and RAM 14 may also store one or more program modules. In particular, the mass storage device 15, the ROM 16, and the RAM 14 may store the program modules associated with the GRC automation system 110 for execution by the CPU 10. The mass storage device 15, the ROM 16, and the RAM 14 may also store other types of program modules.

In general, software applications or modules such as those associated with the GRC automation system 110 may, when loaded into the CPU 10 and executed, transform the CPU 10 and the overall computer 600 from general-purpose computing systems into special-purpose computing systems customized to perform automated GRC management. The CPU 10 may be constructed from any number of transistors or other discrete circuit elements, which may individually or collectively assume any number of states. More specifically, the CPU 10 may operate as one or more finite-state machines, in response to executable instructions contained within the software or modules. These computer-executable instructions may transform the CPU 10 by specifying how the CPU 10 transitions between states, thereby physically transforming the transistors or other discrete hardware elements constituting the CPU 10.

Encoding the software or modules onto the mass storage device 15 may also transform the physical structure of the mass storage device 15 or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for automating governance, risk, and compliance management are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for compliance management of regulations for managed entities, the method comprising computer-implemented operations for:
receiving a set of control objectives mapped to the regulations;
receiving a set of scopes mapped to the managed entities;
generating harmonized test results for the control objectives;
identifying harmonized test results for a subset of the control objectives mapped to one or more specified regulations for the managed entities within a specified one of the set of scopes; and
generating a compliance report based upon the identified harmonized test results.

2. The computer-implemented method of claim 1, further comprising receiving abstraction knowledge.

3. The computer-implemented method of claim 1, further comprising retrieving information related to the managed entities from a service management system.

4. The computer-implemented method of claim 2, wherein the scopes mapped to the managed entities are mapped based upon the abstraction knowledge.

5. The computer-implemented method of claim 2, wherein the control objectives mapped to the regulations are mapped based upon the abstraction knowledge.

6. The computer-implemented method of claim 2, wherein the abstraction knowledge is received from knowledge transactions.

7. The computer-implemented method of claim 2, wherein the abstraction knowledge is received from knowledge plug-ins.

8. The computer-implemented method of claim 1, further comprising retrieving information related to the managed entities from an element manager associated with a service management module.

9. The computer-implemented method of claim 1, further comprising retrieving information related to the managed entities from a configuration management module associated with a service management module.

10. The computer-implemented method of claim 6, wherein the knowledge transactions occur within an on-line content store.

11. A computer-readable medium having computer-executable instructions stored thereon which, when executed by a computer, cause the computer to
receive a set of control objectives mapped to regulations;
receive a set of scopes mapped to managed entities; and
generate a compliance report of harmonized test results for one or more specified ones of the control objectives applied to managed entities within a specified one of the set of scopes.

12. The computer-readable medium of claim 11, wherein the computer is further caused to receive abstraction knowledge.

13. The computer-readable medium of claim 11, wherein the computer is further caused to retrieve information related to the managed entities from a service management system.

14. The computer-readable medium of claim 12, wherein the scopes mapped to the managed entities are mapped based upon the abstraction knowledge.

15. The computer-readable medium of claim 12, wherein the control objectives mapped to the regulations are mapped based upon the abstraction knowledge.

16. The computer-readable medium of claim 12, wherein the abstraction knowledge is received through knowledge transactions.

17. The computer-readable medium of claim 12, wherein the abstraction knowledge is received through knowledge plug-ins.

18. The computer-readable medium of claim 11, wherein the computer is further caused to retrieve information related to the managed entities from an element manager associated with a service management module.

19. The computer-readable medium of claim 11, wherein the computer is further caused to retrieve information related to the managed entities from a configuration management module associated with a service management module.

20. A computer system comprising:
a processing unit;
a memory operatively coupled to the processing unit; and
a program module which executes in the processing unit from the memory and which, when executed by the processing unit, causes the computer system to automate compliance management by receiving abstraction knowledge;
retrieving enterprise information related to managed entities from a service management module;
mapping a set of regulations onto a set of control objectives based upon the abstraction knowledge;
mapping one or more of the managed entities onto one or more scopes based upon the abstraction knowledge; and
generating a compliance report of harmonized test results for one or more specified ones of the control objectives applied to managed entities within a specified one of the set of scopes.
